(19) United States
(12) Patent Application Publication
(10) Pub. No.: US 2025/0258632 A1
(43) Pub. Date: Aug. 14, 2025

(54) ASSOCIATING PRINTER DATA WITH CANDIDATE PRINTERS

(71) Applicant: HEWLETT-PACKARD DEVELOPMENT COMPANY, L.P., Spring, TX (US)

(72) Inventors: Jordina Torrents BARRENA, Sant Cugat del Valles (ES); Carmen Pardo NOGUERA, Sant Cugat del Valles (ES); Nuria Carol VENTURA, Sant Cugat del Valles (ES)

(73) Assignee: HEWLETT-PACKARD DEVELOPMENT COMPANY, L.P., Spring, TX (US)

(21) Appl. No.: 18/856,374

(22) PCT Filed: Apr. 14, 2022
(86) PCT No.: PCT/US2022/024771

§ 371 Date: Oct. 11, 2024

(51) Int. Cl. G06F 3/12

(52) U.S. Cl. CPC G06F 3/1229; G06F 3/1204; G06F 3/1273; G06F 3/1291

(57) ABSTRACT

A data processing unit is provided comprising a first data module to access printer use data from a first data repository, wherein the printer use data is representative of a usage of an active printer, a second data module to access printer parameters from a second data repository, wherein the printer parameters are representative of a printing property of a plurality of candidate printers, and an analysis module. The data processing unit further comprises an analysis module to process the printer use data and the printer parameters to match one of the candidate printers to the printer use data, and an output module to output an identifier of the candidate printer matched to the printer data.

### BACKGROUND

Printing facilities may use their printers for different types of print jobs or with different printing settings. This may lead to different degrees of productivity. Even when printing efficiency schemes are implemented, a printer may operate inefficiently due to different types of print job, print media or print fluid, for which the printer may not be specifically suitable.

Further, a printer cannot effectively print uninterruptedly due to maintenance processes such as media load, input analysis or calibration. In addition, printing activity may be dependent on printing property of a printing facility, for example in terms of working hours, worker shifts or staff availability.

A decision on what kind of printer may be most suitable to improve printing productivity in a given printing facility may be made based on previous experience or existing commercial relations with printer suppliers. This may include manually analysing printing production plans and past printer acquisitions of different printing facilities. This may be time-consuming, and it may be difficult to compare analysis results among different printing facilities. Further, it may be difficult to identify a potential productivity increase that may be achieved by incorporating new printers into a printer facility.

### DESCRIPTION OF DRAWINGS

The following detailed description will best be understood with reference to the drawings, wherein:

FIG. 1 shows a schematic diagram of a system according to an example;

FIG. 2 shows a schematic graphical representation of determining an operation time of a group of printers according to an example;

FIG. 3 shows a schematic graphical representation of a printer usage parameter of a group of printers as a function of time according to an example;

FIG. 4 shows a table containing printer usage parameters for different groups of printers according to an example;

FIG. 5 shows a flow diagram of a method according to an example.

### DESCRIPTION OF EXAMPLES

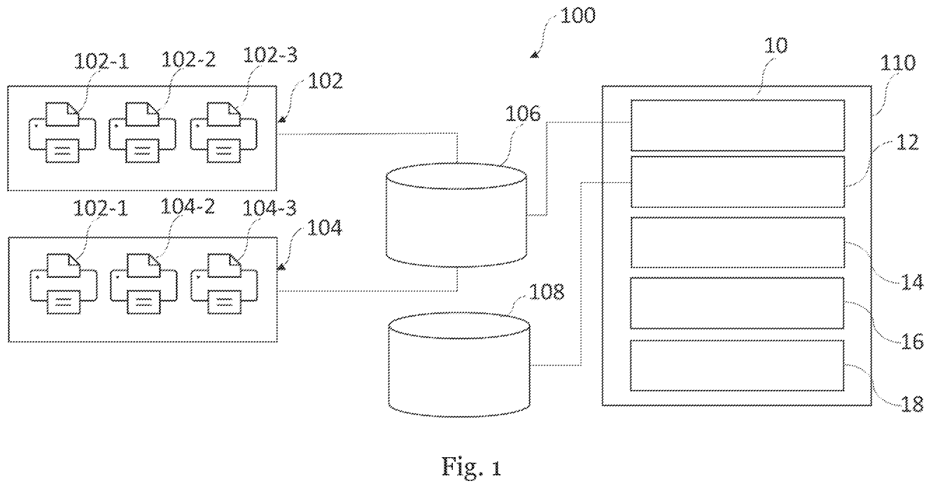

FIG. 1 shows a schematic diagram of a system 100 according to an example. The system comprises a first group of printers 102 and a second group of printers 104. Each of the first and second groups of printers 102 and 104 is connected to a data storage 106 and comprises a plurality of printers. The first group of printers 102 comprises a first plurality of printers 102-1, 102-2, 102-3. The second group of printers 104 comprises a second plurality of printers 104-1, 104-2, 104-3. The printers of each of the groups of printers of the system 100 may be printers of the same type of printer or of different types of printer.

The printers of each of the groups of printers of the system 100 may be referred to herein as available printers, since they may be printers available in a corresponding group of printers for performing print jobs.

In the example of FIG. 1, each of the first and second groups of printers 102 and 104 is represented as including three printers. However, this is just an example and each of the groups of printers of the system 100 may comprise one printer or any number of printers, for instance 2, 4, 5 10, 15, 20, 50, 100 or more.

Likewise, the system 100 is represented in the example of FIG. 1 comprising two groups of printers 102 and 104. However, this is just an example and the system 100 may comprise any number of groups of printers, in particular one group of printers or any larger number of printers, for instance 3, 4, 5, 10, 15, 20, 50, 100 or more.

Each of the printers of the groups of printers 102 and 104 of the system 100 may be, may include, or may be part of a desktop printer, a large format printer, a plotter or the like. Each of the printers of the groups of printers 102, 104 of the system 100 may be a 2D printer or a 3D printer. At least one of the printers of the groups of printers 102, 104 of the system 100 may for example be a latex printer.

The printers of the groups of printers 102, 104 of the system 100 may print a printable medium with a printing fluid. The printing fluid may be an ink, such as a color ink, including CMYK inks, and white ink. The ink may be a latex ink or another type of ink. According to some examples, the printing fluid may be a type of printing fluid used in inkjet type printers, including 2D and 3D printers.

Each of the groups of printers 102, 104 of the system 100, may correspond to a different printing facility, which may be remotely located with respect to each other, for example in different geographical locations. For example, the first group of printers 102 may correspond to a first printing facility of a first client and the second group of printers 104 may correspond to a second printing facility of the first client or of a second client different from the first client.

Each of the groups of printers 102, 104 of the system 100, possibly each of the printers thereof, may be connected to the data storage 106 by means of a wired or wireless connection allowing data transmission, for example via an Internet connection. According to some examples, the data storage 106 may be a physical data storage, such as a hard drive, a flash memory or the like. According to other examples, the data storage 106 may be a remote data storage, for example a cloud-based data storage.

The data storage 106 may be or include one, two or more data repositories containing printer use data received from the printers of the groups of printers 102, 104 of the system 100. Each of the printers of the groups of printers 102, 104 of the system 100 may store respective printer use data in the data storage 106. The printer use data is data representative of a usage of each of the printers of the system 100.

The printers 102-1, 102-2, 102-3 and 104-1, 104-2, 104-3 of each of the groups of printers 102 and 104 of the system 100 may regularly and/or continuously send printer use data to the data storage 106 to store it therein. In some examples, the printers 102-1, 102-2, 102-3 and 104-1, 104-2, 104-3 may store printer use data in the data storage 106 at regular time intervals, for example every 1 minute, every 5 minutes or every 15 minutes, every 1 hour, every 12 hours or every 24 hours.

The printer use data stored by the printers 102-1, 102-2 and 102-3 may be referred to as printer use data of the group of printers 102, whereas the printer use data stored by the printers 104-1, 104-2 and 104-3 may be referred to as printer use data of the group of printers 104.

The printer use data may include user-interaction data registering a number of user-interactions of each of the printers of the system 100 as a function of time. A user-interaction may comprise any of loading of print media, exchanging of printer supplies (e.g., print heads or printer cartridges), inputting a user input and carrying out a calibration process. Any of these user-interactions or any combination thereof may be a user-interaction carried out by a user or operator, i.e., a user-interaction in which a user or operator may interact with a corresponding printer, for example by providing an input or via a physical interaction, for example for replacing a cartridge of the printer. The user-interaction data may register a number of user-interactions as a function of time, i.e., may reflect a register of a number of user-interactions over time. According to some examples, the user-interaction data may comprise a time-register of a number of times a print medium is loaded into any of the printers of a given group of printers 102 or 104.

The printer use data may further include printer activity data registering printer activity of each of the printers of the system 100, possibly as a function of time. “Printer activity” may refer herein to any of printing a print job, scanning a print job, and pre-processing a print job. Thus, whenever any of the printers of a group of printers of the system 100 is undergoing printer activity, for example by performing any of the previously mentioned tasks, that printer may be registered as being active in the corresponding printer activity data.

The system 100 further comprises a data processing unit 110 connected to the data storage 106. The data processing unit 110 may for example be a data processing unit of a server, for example a computer. The server may be remotely connected to the data storage 106 via a wired or wireless connection, for example via an internet connection.

The data processing unit 110 comprises a first data module 10, a second data module 12, an analysis module 14, an optional printer usage module 16, and an output module 18. Each of the modules 10, 12, 14, 16 and 18 may be hardware-based and/or may comprise instructions executable by a processor of the data processing unit 110 to implement the functions described in further detail below. At least one of the modules 10, 12, 14, 16 and 18 may be integrated in a single combined module in some examples. In some examples, the data processing unit 110 needs not include the printer usage module 16.

In the example shown in FIG. 1, the optional printer usage module 16 is connected to a further data storage 108. The data storage 108 may be or include a data repository containing printer parameters representative of at least one printing property of a plurality of candidate printers.

In the example shown in FIG. 1, the data storage 108 may be an independent data storage 108 that may be connected to the printer usage module 16 by means of a wired or wireless connection allowing data transmission, for example via an Internet connection. According to some examples, the data storage 108 may be a physical data storage, such as a hard drive, a flash memory or the like. According to other examples, the data storage 108 may be a remote data storage, for example a cloud-based data storage. However, in other examples (not shown), the data storage 108 may be included in or be identical with the data storage 106 or may be included in the printer usage module 16.

The candidate printers may be printers that may be potentially incorporated into one of the groups of printers 102, 104 of the system 100. According to some examples, the candidate printers may be different printers from a printer catalogue or different printers manufacturable by a printer manufacturer or different printers suppliable by a printer provider.

The printer parameters may be representative of at least one printing property of the candidate printers. The printer parameters may characterize the printing ability of the different candidate printers. The printer parameters may comprise information about any of print jobs, print fluid use, print media use, printing times, printing modes, printing speed and calibration processes. In some examples, the printer parameters may be contained in or be part of the printer use data. The printer parameters may be stored over time.

The candidate printers may include at least one type of printer of the printers available in the system 100, for example at least one type of printer corresponding to one of the printers 102-1, 102-2, 102-3, 104-1, 104-2 or 104-3. The printer parameters may characterize at least one printing property of at least one of the available printers 102-1, 102-2, 102-3, 104-1, 104-2 or 104-3.

According to some examples, the printers of the groups of printers 102 and 104 may store printer parameters characterising printing properties of each of the available printers in the data storage 106 or 108 over a predefined period of time, for example over 1 month or 1 year. In some examples, the data storage 106 may comprise a first data repository storing the printer use data and a second data repository storing printer parameters of the available printers, and the system need not include the data storage 108.

FIG. 5 shows a schematic flow diagram of a method 200 that may be implemented by the data processing unit 110. The method 200 may be a computer-implemented method. The data processing unit 110 may implement the method 200 for associating to at least one of the groups of printers 102 and 104 a selected candidate printer. The selected candidate printer may be selected among the candidate printers, the printing properties of which are represented by the printer parameters stored in the data storage 106 or 108. The selected candidate printer may correspond to a recommendation for a new printer to be incorporated into at least one of the groups of printers 102 and 104 to increase a printing productivity thereof.

The first data module 10 may access the printer use data in the data storage 106. Accessing the printer use data may comprise receiving the printer use data in the first data module 10. At 202, the first data module 10 may load from the data storage 106 the printer use data stored therein, which may characterize the operation of each printer of a group of available printers, for example of the printers 102-1, 102-2, 102-3 of the group of printers 102 and/or of the printers 104-1, 104-2, 104-3 of the group of printers 104.

At 204, optional printer usage module 16 may process the printer use data received from the data storage 106 to determine an operation time for each of the first and second groups of printers 102 and 104.

The operation time registered for each of the groups of printers of the system 100 may correspond to a time during which the respective group of printers is operational. “Operational” may refer herein to the possibility of processing or performing a print job, irrespectively of whether this possibility is actually exploited or not. According to some examples, a group of printers may be considered to be operational when at least some of the printers thereof are available for processing or performing a print job. According to some examples, a group of printers may be considered not to be operational when the printers thereof are not available for processing or performing a print job, possibly as a consequence of being switched-off, out of service or out of the operational times of the respective group of printers (e.g., out of the regulated working hours of a printing facility).

If the printer use data stored in the data storage 106 comprises user-interaction data, the optional printer usage module 16 may determine the operation time of each of the groups of printers 102 and 104 of the system 100 based on respective user-interaction data. According to some examples, the optional printer usage module 16 may consider each of the groups of printers 102 and 104 to be operational when a number of user-interactions registered in the user-interaction data for any of the printers of the corresponding group of printers per predefined unit of time reaches or exceeds a predefined threshold. Such predefined threshold may be o or a greater number.

For example, the optional printer usage module 16 may consider any of the groups of printers 102 and 104 to be operational when the printers thereof register a number of print media loads per hour greater than 0. Thus, if the printers 102-1, 102-2, 102-3 of the group of printers 102 register at least one print media load per hour, the group of printers 102 may be considered to be operational during that hour and the operation time associated to the group of printers 102 may be determined considering that hour as an hour in which the group of printers 102 was operational. An “hour” may be replaced herein by any other predefined unit of time.

According to some examples, a number of user-interactions per predefined unit of time, for example a number of any of loading of print media, exchanging of printer supplies, inputting a user input, carrying out a calibration process, or a combination thereof per predefined unit of time, may be used instead of the number of print media loads per predefined unit of time as a criterion for considering a group of printers to be operational for determining the corresponding operation time. These are processes that may be performed before and after processing or performing a print job and may hence be indicative of a time during which an available printer may be operational despite not being currently active. Using a combination of different types of user-interaction for determining the operation time may provide a more accurate way of determining the time in which a group of printers is operational.

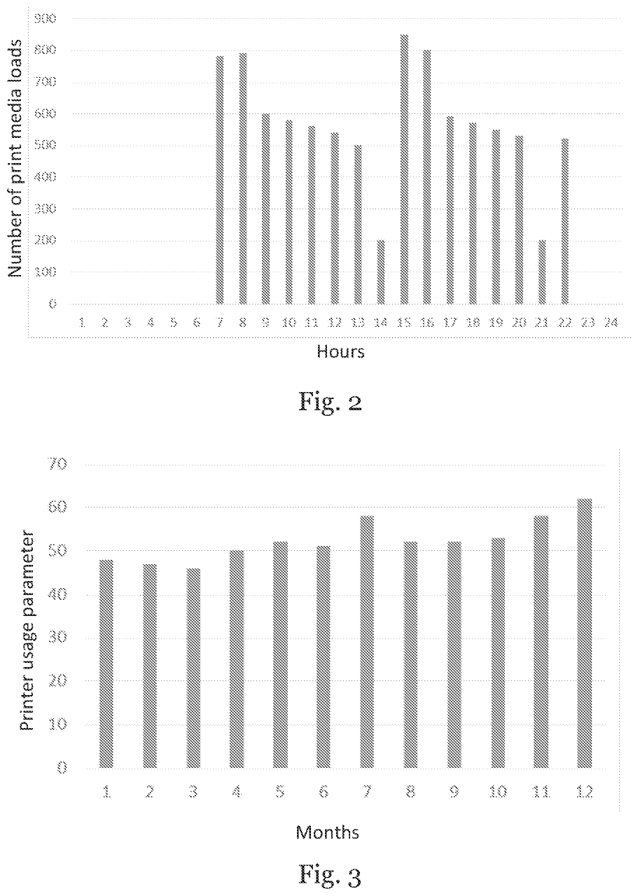

FIG. 2 shows a schematic graphical representation of determining an operation time of a group of printers over 1 year according to an example. According to the example, the optional printer usage module 16 may register a number of print media loads of each of the printers 102-1, 102-2 and 102-3 of the first group of printers 102 over an analysis time, which in the example corresponds to 24 hours (1 h to 24 h), which are represented in the horizontal axis. The vertical axis corresponds to the corresponding number of print media loads in each hour of the day average over 1 year. The printer use data used herein may have been obtained over a monitoring time that may be longer than the analysis time. In the example, the printer use data may have been obtained over 1 year and mean values may be obtained for each hour of the analysis time of 24 hours.

In the example, the first group of printers 102 may be considered to be operational when the number of print media loads per hour of at least one of the printers 102-1, 102-2 and 102-3 is greater than 0. In the example, the user-interaction data represented in FIG. 2 reveals that, over 24 hours, the first group of printers 102 is to be considered operative for an operation time of 16 hours ranging from 7 h (7 am) to 23 h (11 pm).

According to some examples, user-interactions encoded in the printer use data provided by the printers 102-1, 102-2 and 102-3 of the group of printers 102 and stored in the data storage 106 may be used as an indicator of the operability of the corresponding group of printers (printer facility), thereby allowing an accurate and automatized detection of whether the group of printers 102 is or not operational based on data analysis.

As seen in FIG. 2, the user-interaction data, for example the number of print media loads over time, may be used to obtain information about a time distribution of working sheets of a printing facility. In the example of FIG. 2, the data reveals a cyclically decreasing pattern that may be indicative of two different working sheets of the printing facility being analysed, a first working sheet from 7 h (7 am) to 15 h (3 pm), and a second working sheet from 15 h (3 pm) to 23 h (11 pm).

At 206, the optional printer usage module 16 may process the printer use data to determine a printing activity time for each of the first and second groups of printers 102 and 104. The printing activity time registered for each of the groups of printers of the system 100 may correspond to a time during which at least one of the printers 102-1, 102-2 and 102-3 or 104-1, 104-2 and 104-3 of the respective group of printers is active. “Active” may refer herein to a state in which at least one of the printers is processing or performing a print job.

Accordingly, the printer activity time for a given group of printers may be smaller than the operation time of said given group of printers. A difference between the printer activity time associated to a group of printers and a corresponding operation time associated to that group of printers may correspond or be due to an idleness time during which the printers of the group of printers could potentially be used for processing or performing a print job but are actually not being used for that purpose, for example due to their being resting, idle, receiving a user-input, performing a calibration process, undergoing a print medium load, a supply exchange or a combination thereof.

The fact that at least one of the printers of a printing facility is active may imply that that printing facility is operational, while the opposite needs not be true: a printing facility may be operational while none of the printers thereof may active.

If the printer use data stored in the data storage 106 comprises printer activity data, the optional printer usage module 16 may determine the printer activity time of each of the groups of printers 102 and 104 of the system 100 based on the respective printer activity data. According to some examples, the optional printer usage module 16 may consider the printers of each of the groups of printers 102 and 104 to be active when printer activity of any of the corresponding printers is registered in the corresponding printer activity data.

In some examples, the printer usage module 16 may consider the first printing facility 102 to be active when at least one of the printers 102-1, 102-2 and 102-3 is printing a print job, scanning a print job and/or pre-processing a print job. Using more than one type of printer activity for determining the printer activity time may provide a more accurate way of determining the time in which the printers of a printing facility are active.

According to some examples, a single printer activity time may be determined for each printer 102-1, 102-2, 102-3, 104-1, 104-2, 104-3 of each of the groups of printers 102 and 104 and a printer activity time for each of the groups of printers 102, 104 may be determined based on the single printer activity times of the corresponding group of printers. According to some examples, the printer activity time for each of the groups of printers may be determined as the mean value or the maximal value of all single printer activity times of the corresponding group of printers.

In some examples, the printer usage module 16 may determine a first single printer activity time for the first printer 102-1 of the first group of printers 102, a second single printer activity time for the second printer 102-2 of the first group of printers 102 and a third single printer activity time for the third printer 102-3 of the first group of printers 102. For each single printer activity time, the corresponding printer 102-1, 102-2 or 102-3 may be considered active when printer activity is registered in the corresponding printer use data, for example when the corresponding printer 102-1, 102-2 or 102-3 is printing a print job, scanning a print job, pre-processing a print job or a combination thereof. The optional printer usage module 16 may then determine the printer activity time for the first group of printers 102 as the mean value or the maximal value of the first single printer activity time, the second single printer activity time and the third single printer activity time.

According to some examples, the printer activity time t_{act} for a group of printers having N printers may be determined from the single printer activity times t_{act}ⁱ determined for each of the printers as:

$${t}_{act} = \frac{1}{N} {\sum }_{i = 1}^{N} {t}_{act}^{i} .$$

According to some examples, printer activity encoded in the printer use data provided by the printers of a group of printers and stored in the data storage 106 may be used as an indicator of the activity of the printers of the corresponding group of printers (printer facility), thereby allowing an accurate and automatized detection of activity times of a group of printers via data analysis, in particular a differentiation of printer activity times from printer idleness times and from operation time of a group of printers. The optional printer usage module 16 may perform processes 204 and 206 in any order or simultaneously.

At 208, the printer usage module 16 may determine a printer usage parameter corresponding to a ratio of the printer activity time over the operation time. A printer usage parameter may be determined for each group of printers 102, 104 based on the respective printer use data. The printer usage parameter may correspond, in each case, to a ratio of the respective printer activity time over the respective operation time of a respective group of printers 102 or 104. The printer usage parameter may be averaged over a predefined period of time, for example over 1 hour, 1 day, 1 week or 1 month.

FIG. 3 shows a schematic graphical representation of a printer usage parameter of a group of printers according to an example related to the example of FIG. 2. According to this example, a printer usage parameter U for each group of printers may be determined from the corresponding printer activity time t_{act} and the corresponding operation time t_{group} as:

$$U = \frac{{t}_{act}}{{t}_{group}} ,$$

wherein the printer activity time t_{act} and the operation time t_{group} are measured over the same analysis time period.

For example, if the printer use data analyzed for determining the printer usage parameter U corresponds to an analysis time period of 24 hours, the corresponding operation time t_{group} may be 16 hours, indicating that the group of printers being analysed, for example the group of printers 102, was operational ⅔ of the analysis time period, and the corresponding printer activity time t_{act} may be 8 hours, indicating that, on overage, the printers of the group of printers, for example the printers 102-1, 102-2 and 102-3, analyzed were active ⅓ of the monitoring time, i.e., ½ of the operation time, corresponding to a printer usage parameter U=½ (50%).

According to the example of FIG. 3, a printer usage parameter U is determined for a group of printers averaging over a predefined time (in the example an average value is obtained for each month) over the overall analysis time period (in the example 1 year). For each month, the printer usage parameter obtained for a group of printers 102 or 104 may be averaged. As a result, a monthly evolution of the printer usage parameter of a group of printers over 1 year is obtained. The 12 months of the year are represented in the horizontal axis of FIG. 3, while the corresponding printer usage parameter is represented as a percentage in the vertical axis.

According to some examples, a printer usage parameter may be obtained for each group of printers (printing facility) of a plurality of groups of printers (printing facilities) to obtain a mutually comparable measure of the productivity of each printing facility based on data provided by the respective available printers. The printer usage parameter may be obtained by the printer usage module 16. The printer usage parameters may be defined herein as a ratio of actual production time (printer activity time) of the available printers of a group of printers over possible production time (operation time) of the corresponding group of printers. This printer usage parameters allows quantifying printing productivity based on real printing data.

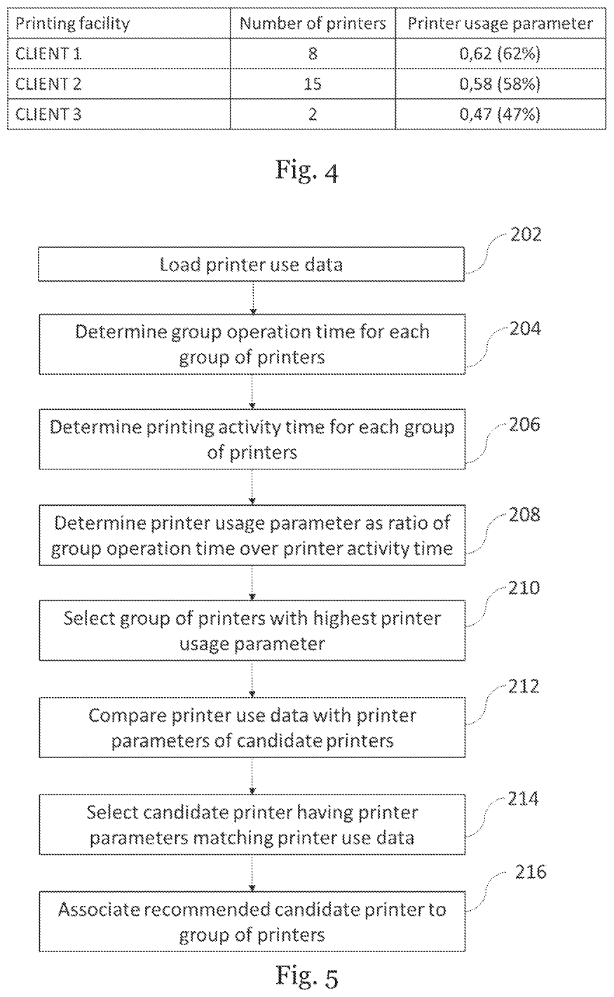

The printer usage parameter may allow identifying printing facilities being more or most productive as printing facilities that would benefit more or most from incorporating new printers into their printing facility. FIG. 4 shows a table containing printer usage parameters for different groups of printers, each corresponding to a respective printing facility (CLIENT 1, CLIENT 2, CLIENT 3), which may be obtained from respective printer use data stored in the data storage 106 for each of the groups of printers.

The printer usage parameters shown in Table 1 may be determined for a predefined time period, for example for 1 month. Thus, the printer usage parameters shown in Table 1 may be determined based on printer use data stored by the available printers of each of the groups of printers CLIENT 1, CLIENT 2, CLIENT 3 over 1 month. For the first group of printers CLIENT 1, comprising 8 printers, a printer usage parameter of 0.62 (62%) is determined. For the second group of printers CLIENT 2, comprising 15 printers, a printer usage parameter of 0.58 (58%) is determined. For the third group of printers CLIENT 3, comprising 2 printers, a printer usage parameter of 0.47 (47%) is determined.

In the table of FIG. 4, the groups of printers are in decreasing order of printer usage parameter. The first group of printers, CLIENT 1, may be identified as a group of printers having a printer usage parameter greater than the printer usage parameters of the remaining groups of printers CLIENT 2 and CLIENT 3. Accordingly, the group of printers with the highest printer usage parameter CLIENT 1 may be identified as the group of printers that would benefit most from incorporating a new printer.

At 210, the printer usage module 16 may select a group of printers having a printer usage parameter higher than other groups of printers. The printer usage module 16 may select a group of printers having a maximal printer usage parameter. In the example of FIG. 4, CLIENT 1 may be a selected group of printers. The printer usage module 16 may report the selected group of printers to the analysis module 14.

According to some examples, the printer use data stored by the available printers of each group of printers in the data storage 106 may comprise data characterising at least one printing property of the available printers. In some examples, the printer use data may comprise data characterizing the printing ability of the different types of available printer. The printer use data may comprise information about any of print jobs, print fluid use, print media use, printing times, printing modes, printing speed and calibration processes of the available printers. Such data may be directly comparable to the previously mentioned printer parameters or be part thereof.

Thus, going back to the examples illustrated in FIG. 2 and FIG. 3, the printers of the groups of printers 102 and 104 may store in the data storage 106 over 1 year, not only the user-interaction data on which the diagram of FIG. 2 is based and the printer activity data additionally used for the diagram of FIG. 3, but also data characterising printing properties of each or the corresponding available printers 102-1, 102-2, 102-3, 104-1, 104-2, 104-3.

Processes 204-210, which may be implemented by the printer usage module 16, are optional. In some examples, the method 200 needs not include processes 204-210, in which case the method 200 may proceed from process 202 to process 212.

According to some examples, the method 200 may comprise, at 212, comparing the printer use data stored in the data storage 106 for each group of printers 102, 104 of the system 100, by the analysis module 14, with the printer parameters for different candidate printers stored in the data storage 108. The printer parameters may be provided for characterising a first candidate printer, for a second candidate printer and for a third candidate printer, and the printer use data may be compared to each of the first to third types of printer.

According to some examples, the analysis module 14 may compare, at 212, the printer use data of a selected group of printers selected by the printer usage module 16 as explained above based on printer usage parameters with the printer parameters. Referring back to the example of FIG. 4, the analysis module 14 may apply process 212 to the group of printers CLIENT 1, possibly leaving out of the analysis the remaining groups of printers CLIENT 2 and CLIENT 3.

In some examples, the plurality of candidate printers may include, as previously mentioned, printers present in at least one of the groups of printers. The printer use data for each group of printers may then be compared to printer parameters corresponding to at least one candidate printer of available printers present in at least one of the groups of printers. A recommended candidate printer outputted by the output module 18 may then correspond to one of the initially available printers. For example, a type of printer corresponding to a printer 102-2 of the group of printers 102 may be recommended as a candidate printer for being incorporated into the group of printers 104 to improve the printing productivity thereof.

The method 200 may comprise selecting, at 214, by the analysis module 14, among the candidate printers represented by the printer parameters, at least one selected candidate printer having printer parameters matching the printer use data. The analysis module 14 may use a similarity metric to match the printer use data to the printer parameters.

For example, a comparison of the printer use data of a group of printers having a highest printer usage parameter (e.g. CLIENT 1 in FIG. 4) with the printer parameters stored in the data storage 108 for a first candidate printer, for a second candidate printer and for a third candidate printer, may reveal that the printer parameters for the first candidate printer is a better match for the printer use data of said group of printers than the printer parameters for the second and third candidate printers. Accordingly, it may be determined that the first candidate printer is best suitable for improving the productivity of said printing facility and the first candidate printer may be selected by the analysis module 14 as the selected candidate printer.

The method 200 may further comprise, at 216, associating the selected candidate printer to the corresponding available printer or groups of printer. For example, if the analysis module 12 compares the printer parameters with the printer use data obtained from a group of printers selected by the printer usage module 16 based on a printer usage parameter, the analysis module 14 may associate the selected candidate printer to the selected group of printers. This may comprise outputting the selected candidate printer by the output module 18.

The outputted recommended candidate printer corresponds to a candidate printer that, based on the analysis of the printer use data and the comparison with the printing properties of the candidate printers, may be a best recommendation for a printer that may be incorporated into a group of printers for improving printing productivity.

The description is not intended to be exhaustive or limiting to any of the examples described above. The printer, method and user interface disclosed herein can be implemented in various ways and with many modifications without altering the underlying basic properties. The methods and user interface can be implanted in a printer as shown in FIG. 1, including variations of that printer and other types of printers, as outlined above. Moreover, the aspects of the printer, the methods and the user interface described herein can be combined, in total and in part, and can be modified within the scope of the following claims.

1. A data processing unit comprising:
a first data module to access printer use data from a first data repository, wherein the printer use data is representative of a usage of an available printer,
a second data module to access printer parameters from a second data repository,
wherein the printer parameters are representative of a printing property of a plurality of candidate printers,
an analysis module to process the printer use data and the printer parameters to match one of the candidate printers to the printer use data, and
an output module to output an identifier of the candidate printer matched to the printer data.

2. The data processing unit of claim 1, wherein the printer use data comprises at least one of: print fluid use data representative of a usage of print fluid by the available printer, print medium use data representative of a usage of print medium by the available printer, and operation time data representative of an operation time of the available printer.

3. The data processing unit of claim 1, wherein the printer parameters comprise at least one of: print fluid parameters representative of a usability of print fluid by the candidate printers, print medium parameters representative of a usability of print medium by the candidate printers, and operation time parameters representative of a usability of the candidate printers.

4. The data processing unit of claim 1, wherein the candidate printers include a type of printer of the available printer.

5. The data processing unit of claim 1, wherein the analysis module matches the one of the candidate printers to the printer use data based on a similarity metric.

6. A system comprising
a data storage,
a printer connected to the data storage to store printer use data in the data storage,
wherein the printer use data is representative of a usage of the printer, and
a data processing unit connected to the data storage to:
compare the printer use data with printer parameters characterizing the printing property of each of a plurality of candidate printers, and
select one of the candidate printers having printer parameters matching the printer use data based on a similarity metric; and
output the selected candidate printer.

7. The system of claim 6, wherein the data processing unit comprises a usage processing module to:
determine, based on the printer use data, an operation time corresponding to a time during which the printer is operational, and a printer activity time corresponding to a time during which the printer is active,
determine a printer usage parameter corresponding to a ratio of the printer activity time over the operation time, and
wherein the data processing unit compares the printer use data with the printer parameters and selects and outputs the selected candidate printer subject to a condition based on the printer usage parameter.

8. The system of claim 7, wherein the printer use data comprises user-interaction data registering a number of user-interactions of the printer as a function of time, and wherein the usage processing module determines the operation time based on the user-interaction data considering the printer to be operational when the number of user-interactions reaches or exceeds a predefined threshold number of user-interactions per predefined unit of time.

9. The system of claim 8, wherein the user-interactions comprise at least one of loading of print media, exchanging of printer supplies, inputting a user input, and carrying out a calibration process.

10. The system of claim 7, wherein the printer use data comprises printer activity data registering printer activity of the printer,
wherein the usage processing module determines the printer activity time considering the printer to be active when printer activity is registered for the printer, wherein the printer activity comprises at least one of printing a print job, scanning a print job, and pre-processing a print job.

11. The system of claim 7, wherein a plurality of groups of printers are connected to the data storage to store respective printer use data therein, wherein the printer use data is representative of a usage of printers of a respective group of printers,
wherein the usage processing module determines a printer usage parameter for each of the groups of printers based on the respective printer use data as a ratio of a respective printer activity time over a respective printer operation time, and
wherein the data processing unit selects one of the groups of available printers based on the determined printer usage parameters, compares the printer use data of the selected group of printers with the printer parameters, selects, one of the candidate printers having printer parameters matching the printer use data of the selected group of printers based on the similarity metric, and outputs the selected candidate printer.

12. A method comprising:
loading printer use data characterizing the operation of an available printer,
comparing the printer use data with printer parameters characterizing the printing property of each of a plurality of candidate printers, and
selecting one of the candidate printers having printer parameters matching the printer use data according to a similarity metric; and
associating the selected candidate printer to the available printer.

13. The method of claim 12, comprising:
loading printer use data characterizing the operation of each available printer of a group of available printers,
comparing the printer use data with the printer parameters, and
selecting one of the candidate printers having printer parameters matching the printer use data according to the similarity metric; and
associating the selected candidate printer to the group of available printers.

14. The method of claim 13, comprising:
loading printer use data characterizing the operation of each group of printers of a plurality of groups of available printers,
comparing the printer use data of at least one of the groups of available printers with the printer parameters, and
selecting, for each of the at least one of the groups of available printers, one of the candidate printers having printer parameters matching the respective printer use data according to the similarity metric; and
associating, to each of the at least one groups of available printers, the respective one of the candidate printers.

15. The method of claim 14, further comprising:
determining a printer usage parameter for each of the groups of available printers of the plurality of groups of available printers, wherein the printer usage parameter is determined based on the respective printer use data as a ratio of a respective printer activity time corresponding to a time during which at least one available printer of the respective group of printers is active over a respective operation time corresponding to a time during which the respective group of available printers is operational, and selecting a group of available printers as the at least one of the groups of available printers based on the respective printer usage parameters determined for each of the groups of available printers.
